(19) United States
(12) Patent Application Publication
(10) Pub. No.: US 2010/0303331 A1
(43) Pub. Date: Dec. 2, 2010

(54) SPECIMEN PROCESSING APPARATUS AND SPECIMEN PROCESSING METHOD

(76) Inventor: Teruaki Itoh, Kumamoto-shi (JP)

Correspondence Address: NIXON & VANDERHYE, PC, 901 NORTH GLEBE ROAD, 11TH FLOOR, ARLINGTON, VA, 22203, US

(21) Appl. No.: 12/775,754

(22) Filed: May 7, 2010

(30) Foreign Application Priority Data
Jun. 2, 2009 (JP) 2009-133274

(51) Int. Cl. G06K 9/62

(52) U.S. Cl. 382/134

(57) ABSTRACT

According to an example of the invention, a specimen processing apparatus includes, image detection unit for detecting image data on a specimen before an analytical process to analyze the specimen, and chyle-laky blood detection unit for detecting a chylous or laky state of the specimen by the color of the specimen, based on the detected image data.

### CROSS-REFERENCE TO RELATED APPLICATIONS

This application is based upon and claims the benefit of priority from prior Japanese Patent Application No. 2009-133274, filed Jun. 2, 2009, the entire contents of which are incorporated herein by reference.

### BACKGROUND OF THE INVENTION

1. Field of the Invention

The present invention relates to a specimen processing apparatus and a specimen processing method applicable to, for example, biochemical analyses.

2. Description of the Related Art

An analyzer (e.g., Jpn. Pat. Appln. KOKAI Publication No. 2008-76185) is known as a specimen processing apparatus that performs various blood examinations, such as biochemical analyses. The analyzer performs an analytical process by, for example, collecting serum as a specimen from blood samples by centrifugation, injecting a reagent into the specimen, and detecting the resulting reaction.

A reading process, aliquoting/dispensing process, etc., are performed as pre-processes prior to the analytical process in each blood examination. In the reading process, data is acquired from a barcode affixed to each specimen container. In the aliquoting/dispensing process, the specimen is aliquoted from the specimen container and dispensed into a sample cup.

Although the serum as a specimen normally has a transparent yellow color, it may become chylous or laky, depending on the individual person (patient. The specimen is cloudy if it is chylous, and is reddish if laky. Since the result of analysis is influenced by the chylous or laky specimen, the chylous or laky state should be grasped in advance. In general, an operator detects the chylous or laky state by visually checking the specimen color or inspecting the specimen by means of an analyzer after a reaction with a reagent.

However, the techniques described above have the following problems. According to the method of detection based on the operator's visual check, so heavy a burden is imposed on the operator that high detection accuracy cannot be easily maintained. It is difficult, moreover, to visually check a large number of specimens, so that the processing efficiency is low. According to the method in which the chylous or laky state is detected by inspecting the specimen by means of the analyzer after the reaction with the reagent, on the other hand, the detection is achieved after the reaction is completed. Since the chylous or laky specimen is subject to different conditions, including the dilution rate of the reagent, the analytical process needs to be performed again. Thus, the processing and use of the reagent are so wasteful that the efficiency is poor.

### BRIEF SUMMARY OF THE INVENTION

According to an example of the invention, a specimen processing apparatus comprises, an image detection unit for detecting image data on a specimen before an analytical process to analyze the specimen, and a chyle-laky blood detection unit for detecting a chylous or laky state of the specimen by the color of the specimen, based on the detected image data.

According to another aspect of the invention, the specimen processing apparatus further comprises a transport unit for holding a specimen container containing the specimen in a standing posture and transporting the specimen container along a predetermined transport path, wherein the image detection unit is located above the transport path and detects the image data by capturing an image of the specimen from above.

According to another aspect of the invention, the specimen processing apparatus further comprises a lighting unit which is disposed between the image detection unit and the transport path and is configured to move up and down between a first position around the specimen container and a second position off and above the specimen container and to irradiate the specimen through the outer periphery of the specimen container.

According to another aspect of the invention, the specimen processing apparatus further comprises a reading unit which reads a label on a lateral portion of the specimen container, thereby acquiring data on the specimen.

According to another aspect of the invention, the specimen processing apparatus further comprises an analytical unit which is disposed downstream relative to the chyle-laky blood detection unit on the predetermined transport path and performs the analytical process in which the specimen is analyzed by a reaction to a reagent.

According to another aspect of the invention, the specimen processing apparatus further comprises an aliquoting/dispensing unit, which is disposed downstream and upstream relative to the chyle-laky blood detection unit and the analytical unit, respectively, on the predetermined transport path and is used to aliquot and dispense the specimen from the specimen container to a sample cup, and a sorting unit, which is disposed downstream and upstream relative to the chyle-laky blood detection unit and the aliquoting/dispensing unit, respectively, on the predetermined transport path and performs a sorting process for the specimen container in accordance with the result of the chyle-laky blood detection.

According to another aspect of the invention, a specimen processing method comprises, detecting image data on a specimen before an analytical process to analyze the specimen, and detecting a chylous or laky state of the specimen by the color of the specimen, based on the detected image data.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a plan view showing a chyle-laky blood specimen detector according to an embodiment of the invention;

FIG. 2 is a front view of the specimen detector according to the embodiment;

FIG. 3 is a side view of the specimen detector according to the embodiment;

FIG. 4 is a side view showing a test tube according to the embodiment;

FIG. 5A is a front view showing an image capture position P1 (lower position) and illustrating the operation of a chyle-laky blood specimen detection section according to the embodiment;

FIG. 5B is a front view showing a retracted position P2 (upper position) and illustrating the operation of the specimen detection section according to the embodiment;

FIG. 6A is a side view showing the image capture position P1 (lower position) and illustrating the operation of the specimen detection section according to the embodiment;

FIG. 6B is a side view showing the retracted position P2 (upper position) and illustrating the operation of the specimen detection section according to the embodiment;

FIG. 7 is a diagram illustrating a chyle-laky blood specimen detection process according to the embodiment;

FIG. 8 is a diagram schematically showing a specimen processing unit according to the embodiment;

FIG. 9 is a view illustrating a sorting device according to the embodiment;

FIG. 10A is a view illustrating an aliquoting/dispensing device according to the embodiment;

FIG. 10B is a view showing sample cups of the aliquoting/dispensing device according to the embodiment;

FIG. 11 is a chart showing processing procedure of the specimen processing unit according to the embodiment; and

FIG. 12 is a flowchart showing processing procedure of the chyle-laky blood specimen detector according to the embodiment.

### DETAILED DESCRIPTION OF THE INVENTION

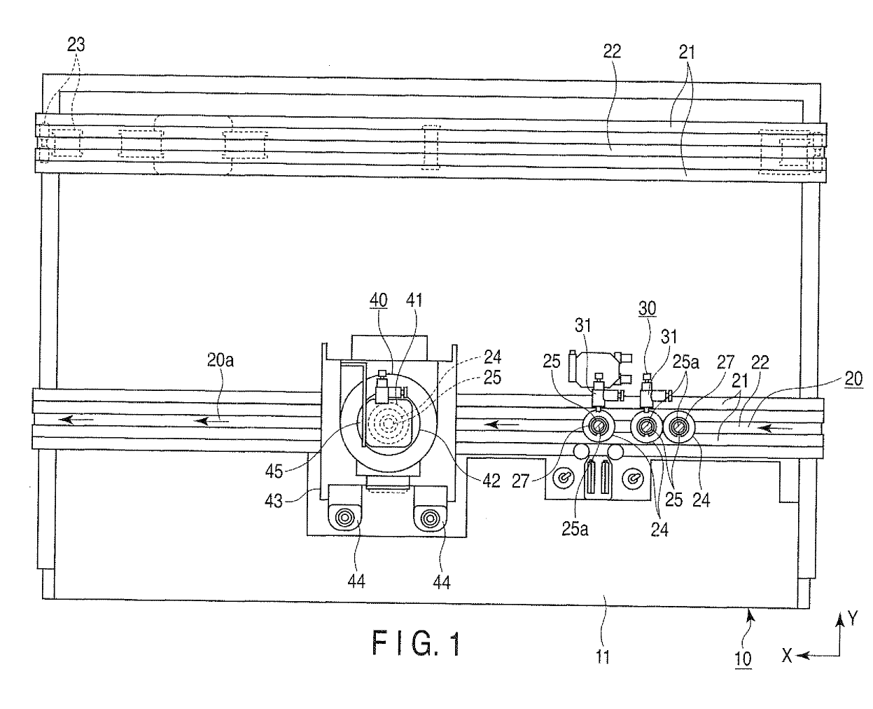

A chyle-laky blood specimen detector 10 for use as a specimen processing apparatus according to an embodiment of the present invention will now be described with reference to FIGS. 1 to 6. In each of these drawings, configurations are enlarged, reduced, or omitted as required. In each drawing, arrows X, Y and Z individually indicate three orthogonal directions.

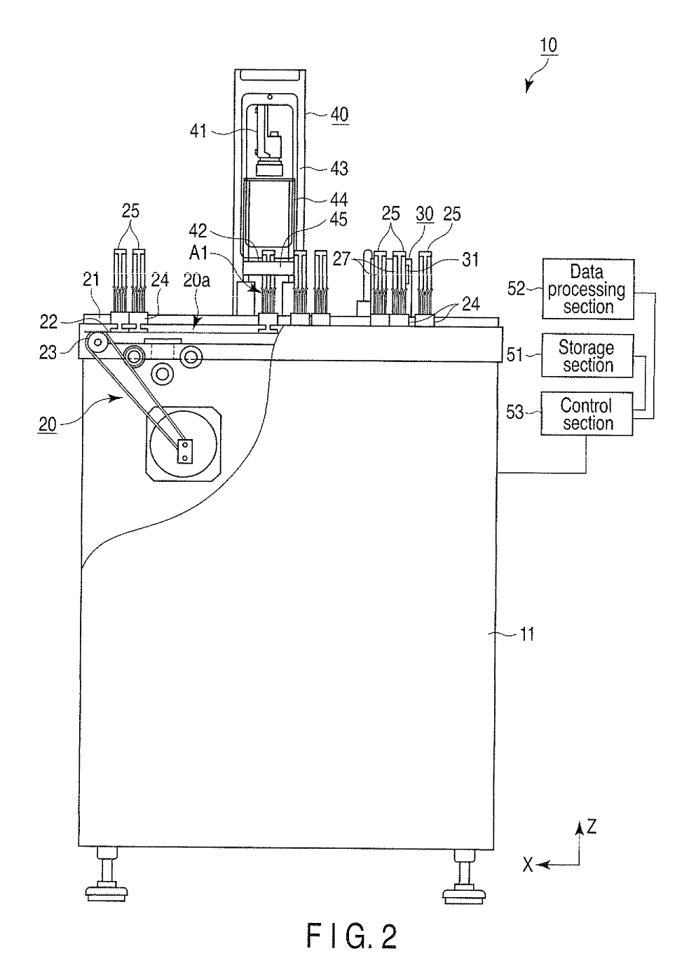

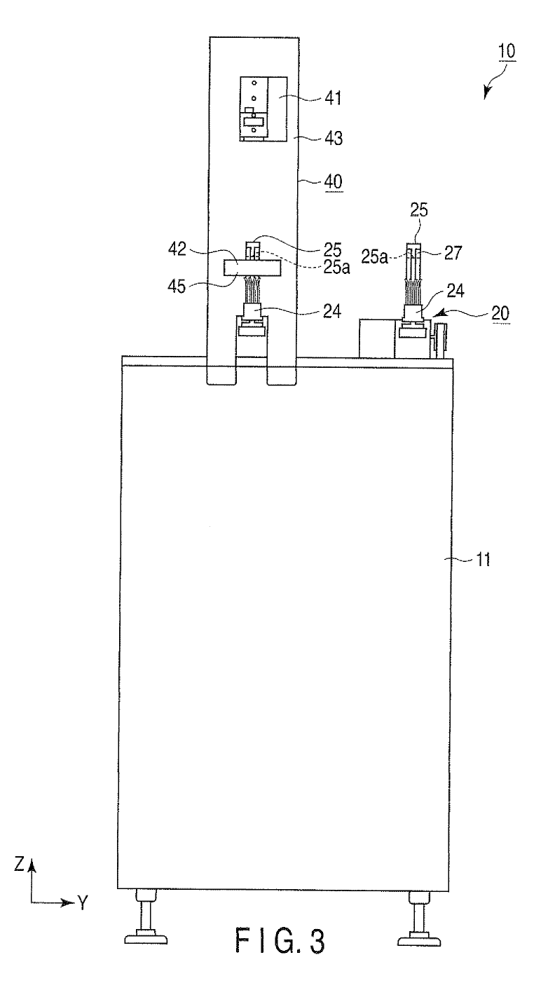

FIG. 1 is a plan view schematically showing a chyle-laky blood specimen detector 10 according to the present embodiment, FIG. 2 is a cutaway front view schematically showing the detector 10, and FIG. 3 is a side view schematically showing the detector 10.

The chyle-laky blood specimen detector 10 is an apparatus that previously detects chylous and laky states of specimens prior to an analytical process for the specimens, and is used as one of pre-processing sections of the specimen processing apparatus for the specimen analytical process, which will be described later.

The chyle-laky blood specimen detector 10 comprises a detector body 11, transport section (transport unit) 20, reading section 30, chyle-laky blood specimen detection section (chyle-laky blood specimen detection unit) 40, storage section (storage unit) 51, data processing section 52, and control section (control unit) 53. The transport section 20 conveys test tubes (specimen containers) 25 along a predetermined transport path 20a. The reading section 30 reads identification data on labels 27 affixed to the test tubes 25. The chyle-laky blood specimen detection section 40 detects the chylous and laky states of the specimens. The storage section 51 stores various items of data. The data processing section 52 performs data processing, such as arithmetic operation and determination, based on results of detection and, identification data, etc. The control section 53 controls operations of the individual sections.

The transport section 20 is a conveyor-type holder transport mechanism disposed in an upper part of the detector body 11. The transport section 20 comprises a pair of guide rails 21, a conveyor belt 22, and conveyor rollers 23. The guide rails 21 are disposed along the transport path 20a, which extends in the X-axis direction in FIGS. 1 to 3, with a fixed space between them. The conveyor belt 22 is located between the guide rails 21 so as to extend throughout the length of the transport path 20a. The conveyor rollers 23 are rotated behind the conveyor belt 22 so as to feed the belt 22.

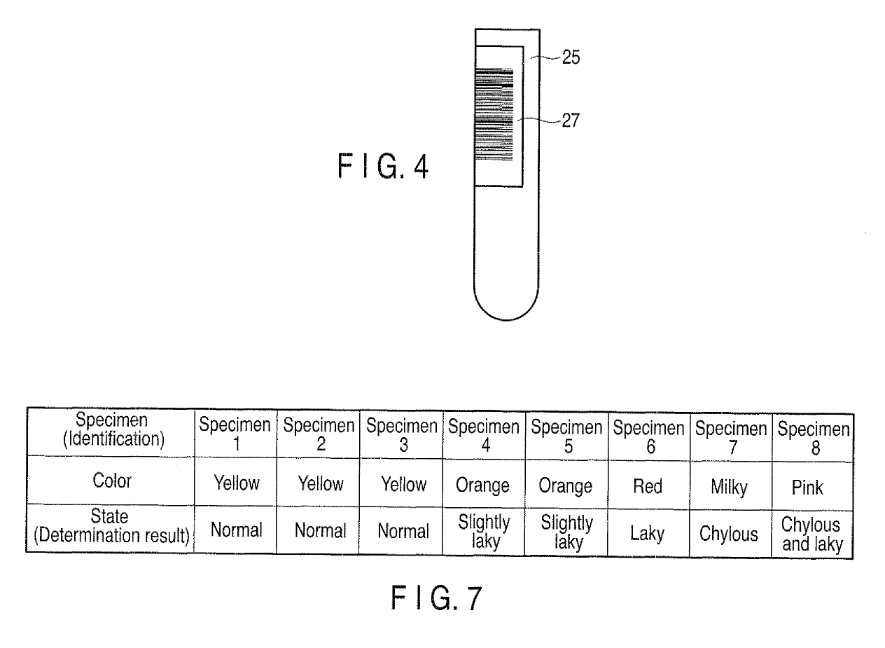

Holders 24 that hold the test tubes 25 are engagedly supported upright between the pair of guide rails 21 and are conveyed as the conveyor belt 22 travels. As shown in FIG. 4, each test tube 25 for use as a specimen container is a cylinder, and a label 27 with a barcode indicative of various items of data, such as identification data, on each specimen is affixed to the side surface of the test tube.

As shown in FIGS. 1 to 3, the reading section 30 comprises a plurality of readers (reading unit) 31, which are arranged beside the transport path 20a and serve to read the labels 27 on the respective side surfaces of the test tubes 25 fed by the transport portion 20, thereby acquiring various items of data on the specimens. The acquired data is recorded in the storage section 51.

The chyle-laky blood specimen detection section 40 comprises an imaging portion (image sensing unit) 41, lighting portion (lighting unit) 42, support mechanism 43, and lift cylinders (lift unit) 44. The imaging portion 41 captures images of the test tubes 25 above the transport path 20a, thereby acquiring image data on the specimens. The lighting portion 42 is disposed above the transport path 20a and irradiates the test tubes 25 while the images are being captured. The support mechanism 43 supports the imaging portion 41 and lighting portion 42. The lift cylinders 44 move the support mechanism 43 up and down.

The imaging portion 41 comprises, for example, a camera and is located above the transport path 20a. The imaging portion 41 captures images of the respective top surfaces of specimens 25a kept upright on the transport path 20a from above, thereby acquiring image data. The acquired image data is recorded in the storage section 51 and delivered to the data processing section 52. The top of each test tube 25 delivered to the imaging portion 41 is open so that the specimen can be seen from above.

The lighting portion 42 comprises a circular light 45 in the shape of a circular ring. The light 45 is located around the test tube 25 when the support mechanism 43 is lowered by the lift cylinders 44 so that the test tube 25 is located in an image capture position P1. The color of the specimen can be clarified to improve the accuracy of the image data by irradiating the outer periphery of the test tube 25 by means of the lighting portion 42 during the image capture.

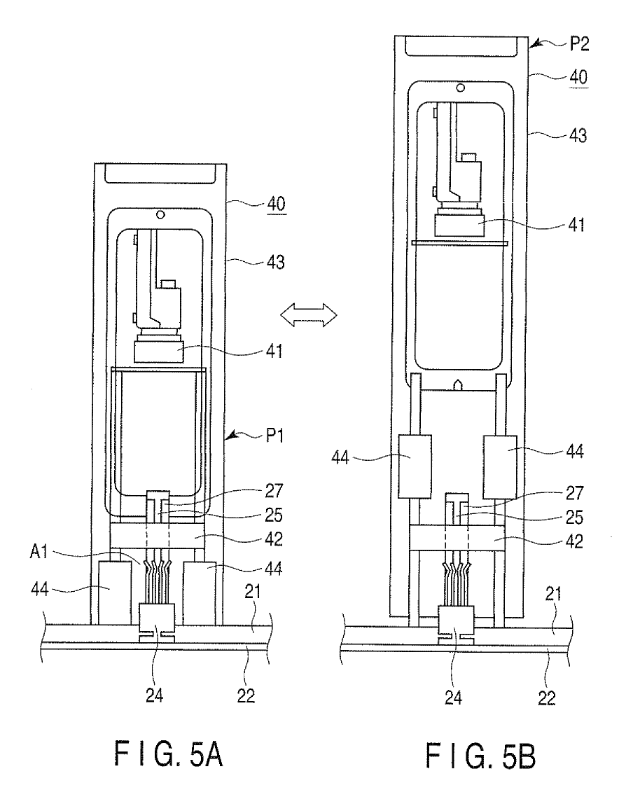

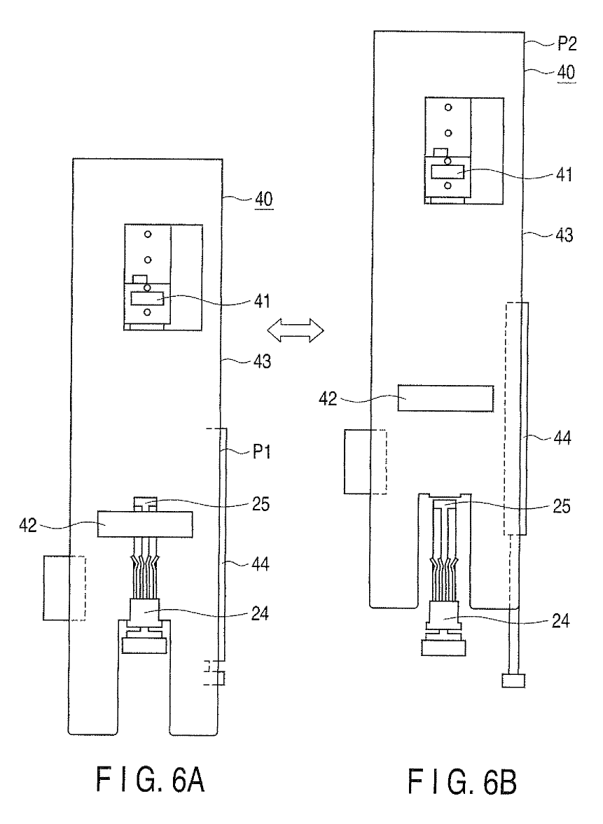

As shown in FIGS. 5 and 6, the support mechanism 43 can reciprocate between the image capture position P1 (lower position) and a retracted position P2 (upper position) as the lift cylinders 44 are driven. The lift cylinders 44 move the support mechanism 43 up and down, thereby raising and lowering the imaging portion 41 and lighting portion 42. If one of the test tubes 25 as an object of detection is stopped at a predetermined area A1, the lift cylinders 44 lower and set the support mechanism 43 in the image capture position P1 as a first position. If an image sensing process is finished, moreover, the support mechanism 43 is raised and set in the retracted position P2 as a second position before the next test tube 25 is conveyed to a predetermined position.

The data processing section 52 detects (and determines) the color of each specimen 25a based on the image data acquired by the imaging portion 41, thereby detecting (and determining) the state of the specimen 25a. As this is done, data processing is performed in association with the identification data of the specimen 25a acquired by the reading section 30. By way of example, in this case, the state in which the specimen color is yellow is regarded as normal, and a determination process is performed by teaching. If the specimen color is, for example, red, pink, or orange, that is, more reddish than in its normal state, the specimen is determined to be laky. If the specimen color is pink or milky, that is, cloudier than in the normal state, on the other hand, the specimen is determined to be chylous. FIG. 7 shows an example of the correspondence between an identification number as specimen identification data, specimen color as a detection result, and specimen state as a determination result. Yellow specimens, such as Specimens 1 to 3, are determined to be normal; orange ones, such as Specimens 4 and 5, as slightly laky; red one, such as Specimen 6, as laky; milky one, such as Specimen 7, as chylous; and pink one, such as Specimen 8, as chylous and laky. These detection and determination results are recorded in the storage section 51, in association with the identification data of the test tubes 25 previously acquired by the reading section 30, and are used for control in the control section 53.

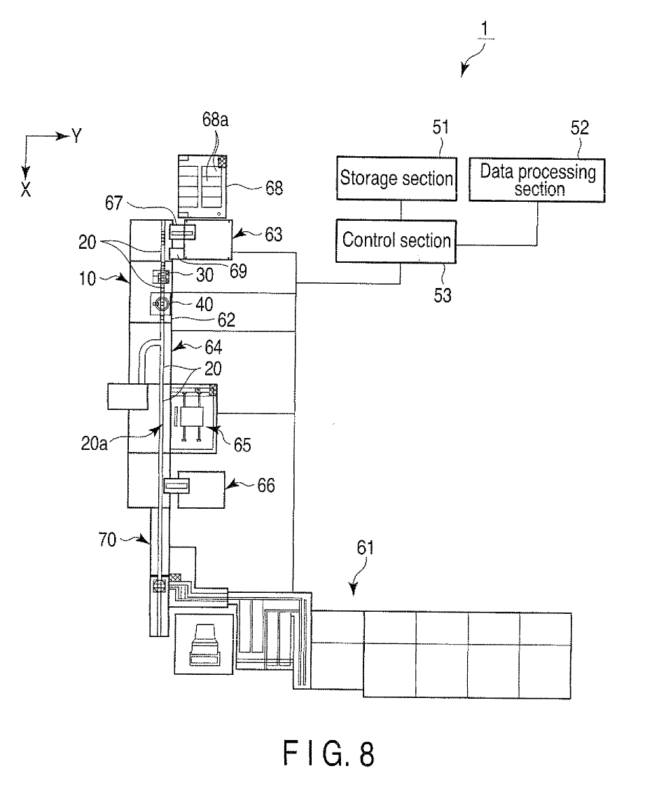

FIG. 8 shows a specimen processing unit (specimen processing apparatus) 1 that comprises the chyle-laky blood specimen detector 10 according to the present embodiment for use as one of the pre-processing devices. In the specimen processing unit 1, an analytical device (analytical unit) 61 and pre-processing unit 62 are connected by a connection path 70. The analytical device 61 analyzes reactions of loaded specimens. The pre-processing unit 62 comprises pre-processing devices that perform various pre-processes prior to the analytical process. The storage section 51, data processing section 52, and control section 53 are connected to the individual devices of the specimen processing unit 1.

In the pre-processing unit 62, a loading device 63, the chyle-laky blood specimen detector 10, a sorting device (sorting unit) 64, an aliquoting/dispensing device (aliquoting/dispensing unit) 65, and an unloading device 66 are arranged downstream in the order of processing from the upstream side of the predetermined transport path 20a. The devices 10 and 63 to 66 are provided individually with the conveyor-type transport sections 20 for conveying the test tubes 25, and the respective transport paths 20a of the transport sections 20 in the pre-processing devices are arranged continuously. The downstream side of the pre-processing unit 62 is connected to the analytical device 61 by the connection path 70 that is continuous with the transport paths 20a.

The loading device 63 comprises a transfer mechanism 67 such as a robotic arm. A rack mounting portion 68 on which a plurality of test tube racks 68a each containing a plurality of test tubes 25 is disposed beside the transport paths 20a. A cap removal portion 69 is disposed downstream relative to the transfer mechanism 67 of the loading device 63. The cap removal portion 69 performs a cap removal process in which it removes a cap from a top opening of each test tube 25.

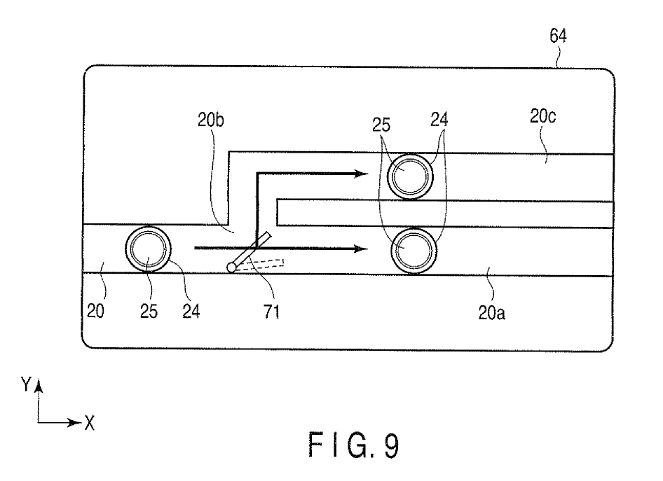

As shown in FIG. 9, the sorting device 64 comprises the transport section 20 for conveying the holders 24 and a gate portion 71 as guide unit for guiding the transport direction of the holders 24 under the control of the control section 53. A branch portion 20b is disposed in the middle of the transport path 20a. A branch path 20c as a different path diverges from the transport path 20a. The gate portion 71 is switchable so as to distribute the test tubes 25 determined to contain chyle or laky blood to the branch path 20c under the control of the control section 53. For example, the test tubes 25 that contain the specimens 25a determined to be chylous or laky in the data processing section 52 are guided to the branch path 20c. The test tubes 25 that contain the normal specimens 25a determined to be neither chylous nor laky are guided downstream along the transport path 20a to the aliquoting/dispensing device 65.

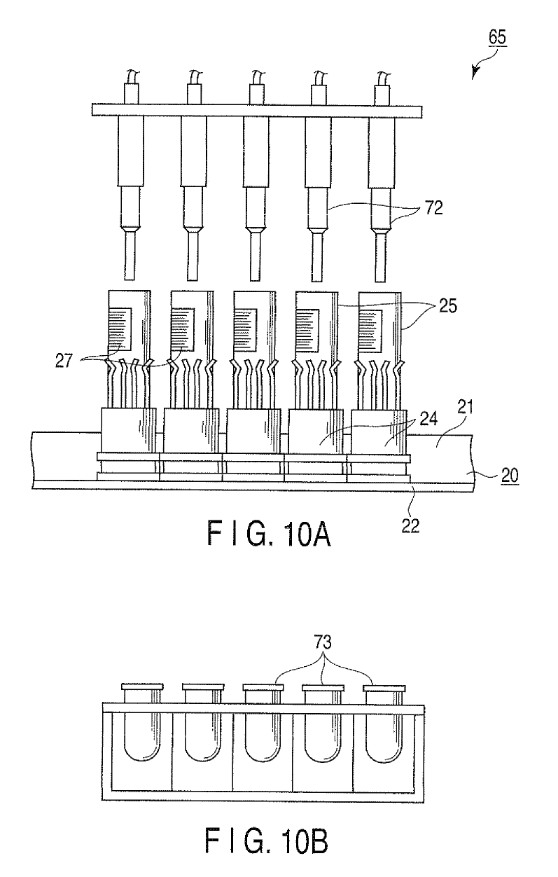

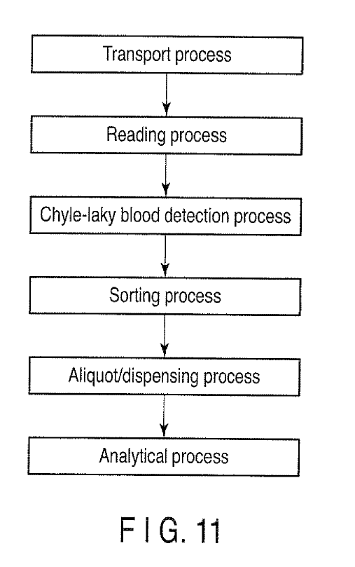

As shown in FIG. 10A and FIG. 10B, the aliquoting/dispensing device 65 comprises the transport section 20 and liftable aliquoting/dispensing tips 72. The transport section 20 conveys the holders 24 along the transport path 20a. The tips 72 are opposed to the respective openings of the test tubes 25. When the test tube 25 is located and stopped at a predetermined position on the transport path 20a, a predetermined amount of serum is aliquoted from each loaded test tube 25 by each tip 72 and dispensed into each of separately delivered sample cups 73 (FIG. 10B). The sample cups 73 into which the serum is dispensed are unloaded from the unloading device 66 and loaded into the analytical device 61 through the downstream connection path 70.

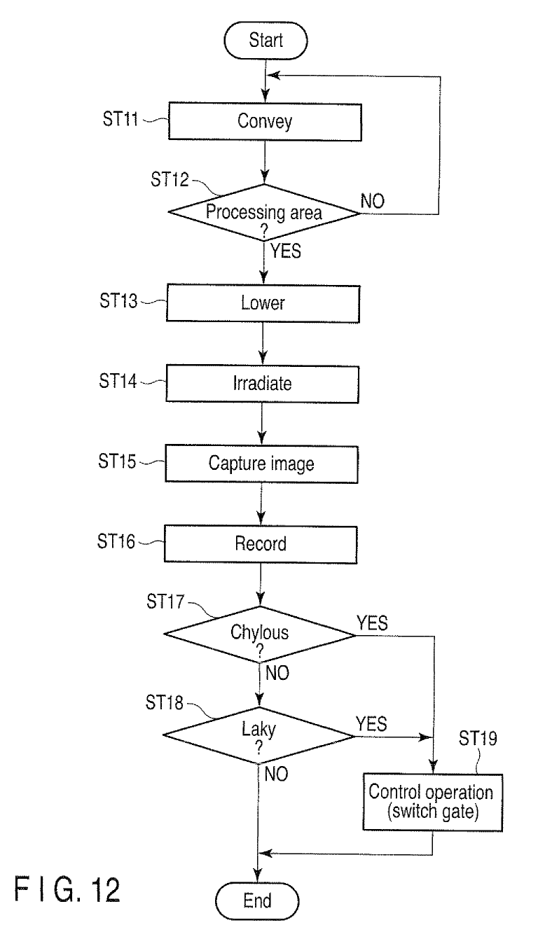

Processing procedure of the specimen processing unit 1 will now be described with reference to FIGS. 11 and 12. FIG. 11 shows a general processing flow of the processing unit 1, and FIG. 12 shows a flow of processing operation of the chyle-laky blood specimen detector 10.

First, a loading process is performed in which the loaded test tubes 25 in the test tube racks 68a are held by the transfer mechanism 67 and transferred onto the transport path 20a. The holders 24 are held on standby on the transport path 20a, and the test tubes 25 are set in the holders 24, individually. The transferred test tubes 25, held in the holders 24, are delivered downstream along the transport path 20a to the reading section 30 of the chyle-laky blood specimen detector 10.

In the reading section 30, a reading process is performed in which data is read from the barcodes on the labels 27 affixed to the respective side surfaces of the test tubes 25, whereby various items of data, such as identification data, are acquired. The acquired data is recorded in the storage section 51. When the reading process is finished, the test tubes 25 are delivered downstream along the transport path 20a to the chyle-laky blood specimen detection section 40.

In the chyle-laky blood specimen detection section 40, a chyle-laky blood specimen detection process is performed to detect the chylous and laky states of the specimens. The chyle-laky blood specimen detection process by the detection section 40 will now be described with reference to FIG. 12. First, the holders 24 holding the test tubes 25 are conveyed (ST11) and stopped at the processing area A1 just below the imaging portion 41 (ST12).

If the test tubes 25 are set in the processing area A1 (Yes in ST12), they are located in the image capture position P1 by lowering the imaging portion 41 and lighting portion 42 together with the support mechanism 43 by means of the lift cylinders 44 (ST13). As this is done, each test tube 25 is inserted into a center space of the circular light 45, whereupon its outer periphery is irradiated by the lighting portion 42 (ST14).

In this state, images of the specimens are captured by the elevated imaging portion 41, whereby image data is acquired (ST15). The acquired image data is recorded in the storage section 51 and delivered to the data processing section 52 (ST16).

The data processing section 52 calculates data indicative of the color of each specimen from the acquired image data and determines whether or not the specimen is chylous, based on the specimen color (ST17). If the specimen color indicates such a value that it is cloudier than those of ordinary serums within a predetermined range, for example, the specimen is determined to be chylous (Yes in ST17). If the specimen color indicates a value for an ordinary serum color, the specimen is determined to be normal (No in ST17).

Further, the data processing section 52 determines whether or not the specimen is laky, based on its color (ST18). If the specimen color indicates such a value that it is more reddish than those of ordinary serums within the predetermined range, the specimen is determined to be laky (Yes in ST18). If the specimen color indicates a value for an ordinary serum color, the specimen is determined to be normal (No in ST18).

The detection and determination results acquired by the data processing section 52 are recorded in the storage section 51, in association with the identification data of the test tubes 25 previously acquired by the reading section 30, and subsequent processing operation is controlled based on the determination result (ST19).

As an example of operation control in ST19, the gate portion 71 is switched in accordance with the determination result by the downstream sorting device 64, under the control of the control section 53, and a process to distribute the test tubes 25 is performed.

When the gate portion 71 is switched to the position indicated by the solid line in FIG. 9, for example, the test tubes 25 that contain the specimens 25a determined to be chylous or laky in the data processing section 52 are guided to the branch path 20c. The downstream side of the branch path 20c is connected to a processing portion to perform another process for chylous or laky specimens different from the process for normal specimens.

On the other hand, each normal specimen determined to be neither chylous nor laky is guided downstream along the transport path 20a to the aliquoting/dispensing device 65 by the gate portion 71 that is located in the broken-line position in FIG. 9.

In the aliquoting/dispensing device 65 shown in FIGS. 10A and 10B, an aliquoting/dispensing process is performed in which a predetermined amount of serum is aliquoted from each test tube 25 loaded with a normal specimen by each aliquoting/dispensing tip 72 and dispensed into each separately delivered sample cup 73. The sample cups 73 into which the serum is dispensed are unloaded from the downstream unloading device 66 and loaded into the analytical device 61 through the downstream connection path 70. Then, in the analytical device 61, an analytical process is performed for the inspection of various reactions.

The chyle-laky blood specimen detector 10 and specimen processing unit 1 according to the present embodiment can provide the following effects. Since the chylous or laky specimens are automatically detected by the specimen detector 10 prior to the analytical process, the state of each specimen can be detected highly accurately and efficiently. Thus, a burden on an operator can be reduced compared to the case of the operator's visual inspection, so that high detection accuracy can be maintained. Further, a large number of specimens can be processed at so high a speed that the processing can be efficiently performed. Moreover, the chylous or laky state is detected before the specimens react to a reagent. Unlike the case of detection by an analytical device after a reaction with the reagent, therefore, the analytical process does not need to be performed again, so that wasteful processing and use of the reagent can be prevented.

Furthermore, the outer periphery of each test tube 25 is irradiated by the circular lighting portion 42 as the images are captured by the imaging portion 41 from above. Therefore, high detection accuracy can be maintained without the influence of the location of the label 27 on the side surface of the test tube 25. Thus, the accuracy of the teaching or the like is improved. In some cases, the label 27 is affixed to the side surface of each test tube 25. If the test tube 25 is laterally irradiated or imaged, the result of image capture may be adversely affected by the position of the label 27. In the present embodiment, the influence of the label position can be avoided to maintain constantly high detection accuracy by irradiating the entire circumference of the test tube 25 by the circular light 45 and imaging the test tube from above. The specimens can be processed appropriately and quickly by controlling the transport direction in accordance with the detection result by means of the sorting device 64.

The present invention is not limited directly to the embodiment described above, and its constituent elements may be embodied in modified forms without departing from the scope or spirit of the invention. For example, the processing apparatus that constitutes the pre-processing unit 62 is not limited to the above-described one. In closing the top opening of each test tube 25 by a cap, for example, the cap removal process may be performed by means of a cap removal apparatus that is located upstream relative to the imaging portion 41. Although the chyle-laky blood specimen detection process is performed for each test tube 25 according to the embodiment described herein, moreover, it may alternatively be performed at a time for a plurality of test tubes 25. Further, a plurality of test tubes 25 in each rack may be conveyed simultaneously.

Further, some of the constituent elements according to the above embodiment may be omitted, and the shapes, structures, materials, etc., of the constituent elements may be changed. Furthermore, various inventions can be formed by appropriately combining the constituent elements disclosed in the above embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A specimen processing apparatus comprising:
an image detection unit for detecting image data on a specimen before an analytical process to analyze the specimen; and
a chyle-laky blood detection unit for detecting a chylous or laky state of the specimen by color of the specimen, based on the detected image data.

2. A specimen processing apparatus according to claim 1, further comprising a transport unit for holding a specimen container containing the specimen in a standing posture and transporting the specimen container along a predetermined transport path, wherein the image detection unit is located above the transport path and detects the image data by capturing an image of the specimen from above.

3. A specimen processing apparatus according to claim 2, further comprising a lighting unit which is disposed between the image detection unit and the transport path and is configured to move up and down between a first position around the specimen container and a second position off and above the specimen container and to irradiate the specimen through the outer periphery of the specimen container.

4. A specimen processing apparatus according to claim 2, further comprising a reading unit which reads a label on a lateral portion of the specimen container, thereby acquiring data on the specimen.

5. A specimen processing apparatus according to claim 1, further comprising an analytical unit which is disposed downstream relative to the chyle-laky blood detection unit on the predetermined transport path and performs the analytical process in which the specimen is analyzed by a reaction to a reagent.

6. A specimen processing apparatus according to claim 5, further comprising an aliquoting/dispensing unit, which is disposed downstream and upstream relative to the chyle-laky blood detection unit and the analytical unit, respectively, on the predetermined transport path and is used to aliquot and dispense the specimen from the specimen container to a sample cup, and a sorting unit, which is disposed downstream and upstream relative to the chyle-laky blood detection unit and the aliquoting/dispensing unit, respectively, on the predetermined transport path and performs a sorting process for the specimen container in accordance with the result of the chyle-laky blood detection.

7. A specimen processing method comprising:
detecting image data on a specimen before an analytical process to analyze the specimen; and
detecting a chylous or laky state of the specimen by color of the specimen, based on the detected image data.
